(19) United States
(12) Patent Application Publication
(10) Pub. No.: US 2002/0191493 A1
(43) Pub. Date: Dec. 19, 2002

(54) Spring, drive mechanism, device and timepiece using the spring

(76) Inventor: Tatsuo Hara, Shimosuwa-machi, Nagano-ken (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/070,797

(22) PCT Filed: Jul. 6, 2001
(86) PCT No.: PCT/JP01/05898

(30) Foreign Application Priority Data
Jul. 11, 2000 (JP) 2000-210158

(51) Int. Cl. G04B 1/10

(52) U.S. Cl. 368/140

(57) ABSTRACT

A barrel gear 1 as a driving mechanism of an electronic control mechanical timepiece has a mainspring 1A having a surface of elastic material coated with a film made of DLC thin film. The mainspring 1A has a superior anti-corrosion property and reduced slide resistance while sufficiently securing both of toughness and rigidity on account of the film, so that proportional limit thereof can be increased to increase energy accumulated in the mainspring 1A.

### TECHNICAL FIELD

The present invention relates to a spring used as a machine element, a driving mechanism, a device and a timepiece using the spring.

### BACKGROUND ART

Conventionally, various springs with elastic modulus in accordance with desired usage have been manufactured by processing a material such as steel and stainless steel having elasticity.

For instance, a coil spring used for driving an intake valve and an exhaust valve of a gasoline engine, a plate spring used for shock absorber provided around wheels of a vehicle and a mainspring used as a power source of toys and timepieces have been known.

Since long drive time and great durability are not required for the mainspring for driving toys, steel-made or stainless-steel-made springs are used.

On the other hand, since long driving time and great durability are required for the springs for driving timepieces such as wristwatch, the springs are made by alloy containing chromium, cobalt, nickel etc. thereby obtaining high-performance spring having excellent allowable stress and fatigue strength.

The springs formed by alloys containing cobalt, nickel etc. are not easy to be corroded by chemicals such as acid and has sufficient corrosion resistance.

Further, when the spring is wound to accumulate sufficient mechanical energy in the spring and the spring is unwound thereafter to extract mechanical energy accumulated in the spring, slide resistance is generated on account of contact between the spring and a case for accommodating the spring such as a barrel and a contact between the sides of the wound spring, thus losing the mechanical energy. Accordingly, the slide resistance of the spring is reduced by a lubricant containing molybdenum disulfide or surface treatment such as Teflon finish.

The energy amount accumulated in the spring such as helical spring is smaller as compared to batteries.

For instance, the density of the energy accumulated in the helical spring of a wristwatch is approximately one thousandth of a primary battery and one tenth of a secondary battery, so that only approximately two days of driving time can be obtained by driving with the spring. On the other hand, more than two years of driving time is possible by driving with the primary battery.

Incidentally, when resistance to corrosion is lost in increasing the energy amount accumulated in the spring such as helical spring, the spring may not be used for long term, thus causing problem for durability.

Further, since the slide resistance is increased in accordance with increase in accumulated energy amount, the mechanical energy obtainable from the spring decreases, so that practically usable energy amount can be insufficient even when the accumulated energy amount increases.

An object of the present invention is to provide a spring capable of increasing accumulated energy amount, a driving mechanism, a device and a timepiece using the spring.

Another object of the present invention is to provide a spring having superior resistance to corrosion, a driving mechanism, a device and a timepiece using the spring.

Further object of the present invention is to provide a spring capable of reducing slide resistance, a driving mechanism, a device and a timepiece using the spring.

### DISCLOSURE OF THE INVENTION

A first aspect of the present invention is a spring manufactured by processing an elastic material, at least a part of the surface of the material formed with a film having composition and mechanical characteristics different from the material.

The elastic material refers not only so-called elastic member having superior elasticity such as steel and stainless steel, but also relatively soft material such as synthetic resin having moderate elasticity.

The film includes a thin film of other substance adhered on the surface of the material, an oxidation film formed by oxidizing the surface of a metal material, and a diffusion layer having other substance diffused from the surface of the material to the inside.

According to the first aspect of the invention, since the spring is formed of a material having mutually different mechanical characteristics, superior anti-corrosion property can be applied on the spring, slide resistance thereof can be reduced and energy accumulative therein can be increased by utilizing the superior mechanical characteristics inherent in the material and the film.

Specifically, the energy U capable of accumulating in the spring can be represented as the following formula:

U=(V/6)*(σ²/E)

In the formula, V represents a volume of a spring, σ represents a proportional limit of a spring and E represents Young's modulus.

According to the formula, since the energy U capable of being accumulated in the spring is inversely proportional to the Young's modulus and is proportional to the square of the proportional limit, when the predetermined Young's modulus is obtained, the proportional limit of the spring may be increased.

Accordingly, by using a highly elastic composition on either one of the material or the film and using a composition of great toughness to the other one of the material and the film, the Young's modulus can be secured while increasing the proportional limit, thereby increasing the accumulative energy amount.

Especially, when the rigid film is formed on the material, both of the Young's modulus and the proportional limit can be increased and the energy U accumulated in the spring is proportional to the square of the proportional limit, so that the accumulative energy can be securely increased when the Young's modules is increased.

When the film is of a composition having superior anti-corrosion property, superior anti-corrosion properties can be given to the spring irrespective of chemical characteristics of the material.

When a composition having superior self-lubricity or a composition having small slide resistance is used for the film, the slide resistance of the spring can be reduced without adding lubricant or surface treatment.

In the above spring, the film may preferably be harder than the material.

When the film is harder than the material, even when the material is relatively soft, sufficiently great Young's modulus can be secured by the film and the proportional limit of the spring can be increased, so that sufficient toughness can be secured by the composition of the material, thereby easily increasing the accumulative energy amount without substantially increasing the volume of the spring.

A plurality of layers of the film may be provided to the spring instead of single film. For instance, a plurality of films having different composition may be laminated, or alternatively, a plurality of films having prominently different content ratio of the composition may be laminated.

According to the above arrangement, even when all of the bonding strength to the material, anti-corrosion property and the slide resistance of the spring cannot be improved by a single film, by providing a plurality type of films having different characteristics, the bonding strength can be improved by one film, and the anti-corrosion properties and slide properties can be improved by the remaining film, thus achieving high-performance spring.

For instance, a first composition having great rigidity and small bonding strength to the material and a second composition which strongly adheres both to a first film and the material may be prepared, and a second film composed of the second composition may be directly formed on the material and a first film composed of the first composition may be formed on the second film, thereby obtaining the first film having great bonding strength.

Alternatively, a first composition having great rigidity and inferior anti-corrosion properties and self-lubricity and a second composition superior both in the anti-corrosion properties and self-lubricity may be prepared, and a first film composed of the first composition may be formed directly on the material and the second film composed of the second composition may be formed on the first film, thereby obtaining a spring superior both in the anti-corrosion property and self-lubricity.

In the above-described spring, the material may preferably be processed in a band-shape and wound in helical shape so that the spring becomes a mainspring.

When the spring is the mainspring, in addition to increase in the accumulative energy by coating the film onto the material, since the shape of the mainspring is suitable for mechanically accumulating the energy, more energy accumulation is possible than the other form of springs of the same size, thereby increasing energy density.

The material may preferably has the film formed on a surface to which a compressive force is applied when the material is elastically deformed.

Accordingly, even when a composition of the film has great rigidity and durability against compressive force but is weak against tension, or when a film having small bonding strength to the material is formed, since the film is formed to a portion where the compressive force is applied, the film is not peeled off from the material even when the spring is deformed, thereby preventing damage of the spring.

The film may be a thin film of a substance harder than the material coated on the surface of the material.

There are various types of the compositions capable of being coated as the film which is highly rigid and is strong against the compression force. Such material can be easily obtained and has small anti-corrosion properties and slide resistance, so that accumulative energy can be increased and a spring having superior anti-corrosion properties and small slide resistance can be obtained by coating the film of the composition.

For instance, when the film mainly made of carbon is coated on the material, hardness similar to diamond can be obtained, energy capable of being accumulated in the spring can be increased, superior anti-corrosion properties can be given to the spring and the slide resistance of the spring can be substantially reduced.

The material may be formed of a non-metal.

According to the above-described first aspect of the present invention, even when the elasticity of the material is not sufficient, in other words, even when sufficient Young's modulus cannot be obtained by the material, sufficient elasticity can be secured by the film, so that the material may be formed by non-metal composition, such as synthetic resin.

Further, composition having superior toughness such as synthetic resin reinforced by aramid fiber can be used as the composition of the material, so that toughness can be increased, thereby also increasing energy accumulation.

The film may preferably be formed on the material by a physical vapor evaporation of which film-forming temperature is around a room temperature.

The physical vapor evaporation may be high-vacuum arc discharge vapor evaporation having film-forming temperature of 0 to 100° C. According to the high-vacuum arc discharge vapor evaporation, the film-forming temperature may be within 20 to 60° C. in forming the material of the carbon film on the material.

Accordingly, the synthetic resin material which is easily influenced by heat can be used as the material, thereby widening selecting range of the composition of the material.

When the material is formed by a material capable of precision processing such as synthetic resin, high-performance spring can be efficiently manufactured with the use of injection molding etc.

On the other hand, the film is not restricted to a thin film coated on the surface of the above-described material, but may be a diffusion layer formed harder than the material by diffusing a diffusion substance strongly bonded with the substance constituting the material from the surface of the material to the inside thereof.

When the diffusion layer is used as the film, since the spring is formed by the material and the film of mutually different mechanical characteristics as in the above arrangement of the thin film as the film, superior anti-corrosion property can be applied on the spring, slide resistance thereof can be reduced and energy accumulative therein can be increased by utilizing the superior mechanical characteristics inherent in the material and the film.

Incidentally, when the material is an stainless steel alloy including chromium, nitrogen to be strongly bonded with chromium may preferably be used as the diffusion substance.

The material may preferably be formed of a metal capable of thermomigration treatment.

By using such metal material, since the mechanical characteristics and shape can be easily preserved even when the metal is heated to a high temperature as compared to the other material such as synthetic resin, the process temperature can be increased in diffusion processing of the material, so that the diffusion speed of the diffusion substance can be accelerated to reduce time required for the diffusion treatment.

The diffusion layer may preferably be formed on the material by a diffusion treatment which supplies a gas including a molecule containing element of the diffusion substance into a high-vacuum furnace and the diffusion substance is diffused from the surface of the material to the inside.

Accordingly, since the hard diffusion layer is formed by mixing diffusion substance into the material, fragile layer is not formed on the border of the diffusion layer and the material, so that damage and peeling of the diffusion layer is not caused even after repetition of the elastic deformation, thereby obtaining a spring of superior durability.

A second aspect of the present invention is a driving mechanism using a spring formed as described above.

According to the second aspect, since the energy capable of being accumulated in the spring increases, continuous driving time can be lengthened as compared to general driving mechanism of the same size.

Further, by selecting the composition of the material and the film in accordance with the usage of the driving mechanism, the performance of the driving mechanism can be improved.

For instance, when a composition of the film has superior anti-corrosion properties, the anti-corrosion properties of the driving mechanism can be improved. Further, when a composition of the film has superior self-lubricity, even when the drive force generated by the spring is the same, the drive force capable of extracting from the driving mechanism becomes stronger than the driving mechanism using an ordinary spring.

A third aspect of the present invention is a device using the above-described spring.

According to the third aspect of the present invention, since the energy accumulated in the spring increases as in the second aspect of the present invention, continuous drive time can be lengthened.

On the other hand, when long drive time is not required, the size of the spring can be reduced, so that the driving mechanism using the spring and, as a result, the size of the device can be reduced.

A fourth aspect of the present invention is a power source of electronic control mechanical timepiece or a simple mechanical timepiece using the above-described spring.

Specifically, the fourth aspect of the present invention is an electronic control timepiece, comprising: a mechanical energy accumulator for accumulating a mechanical energy; a power generator driven by the mechanical energy accumulator; a gear train for mutually connecting the mechanical energy accumulator and the power generator; an indicator connected to the gear train; and a rotation controller for controlling rotary speed of the power generator, or a timepiece comprising a mechanical energy accumulator and being driven by the mechanical energy accumulator, in which the mechanical energy accumulator uses a spring where at least a part of the surface of a material thereof has a film having composition and mechanical characteristics different from the material.

According to the fourth aspect of the present invention, since the energy capable of being accumulated in the spring increases and the energy per certain volume of the spring, i.e. the energy density, can be increased, the duration of the timepiece can be lengthened by the spring of the first aspect of the present invention when the spring of the same size is used. Further, since the size of the spring is reduced when the same duration is to be achieved, the size and weight of the timepiece can be reduced.

### BRIEF DESCRIPTION OF THE DRAWINGS

FIG. 1 is a plan view showing a primary portion of a first embodiment of the present invention;

FIG. 2 is a cross section taken along II-II line in FIG. 1;

FIG. 3 is a cross section taken along III-III line in FIG. 1;

FIG. 4 is a cross section showing a barrel gear of the first embodiment of the present invention;

FIG. 5 is a block diagram showing a rotation control circuit of a power generator of the first embodiment;

FIG. 6 is a plan view-showing a second embodiment of the present invention;

FIG. 7 is a cross section showing a primary portion of the second embodiment; and

FIG. 8 is a cross section showing a primary portion of a third embodiment of the present invention.

### BEST MODE FOR CARRYING OUT THE INVENTION

An embodiment of the present invention will be described below with reference to attached drawings.

[First Embodiment]

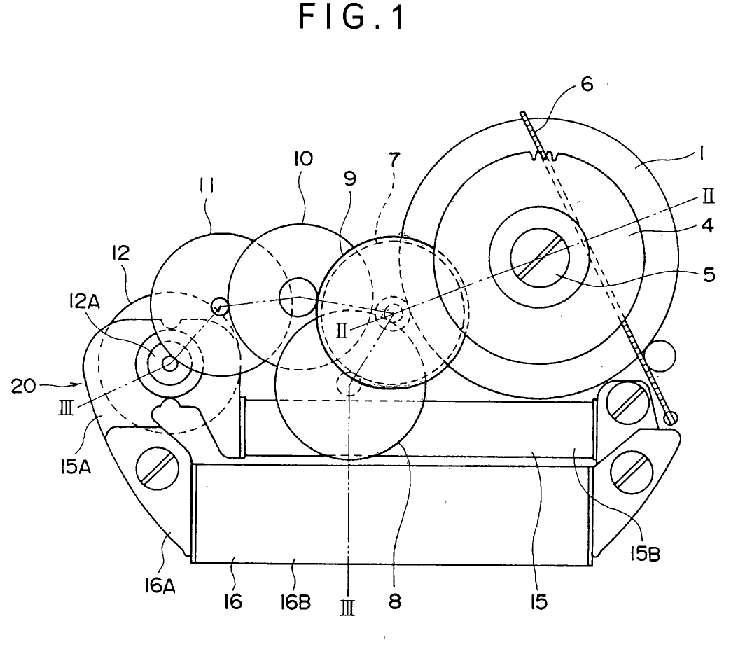

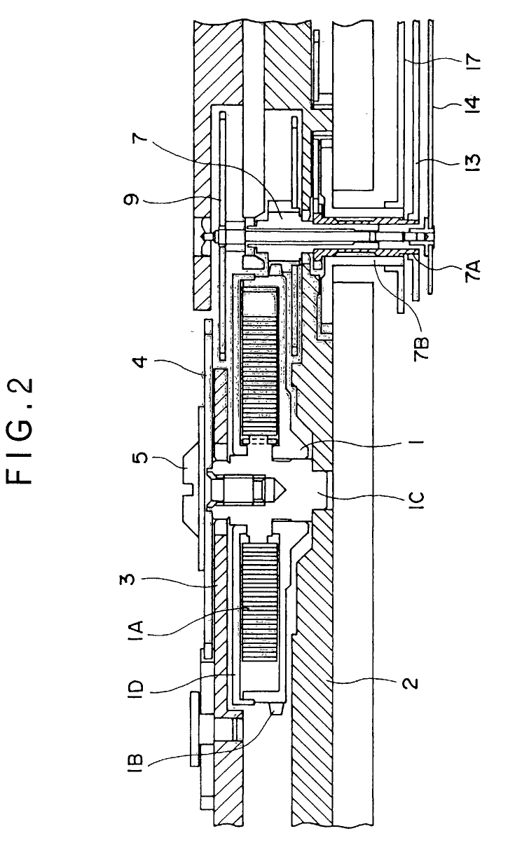

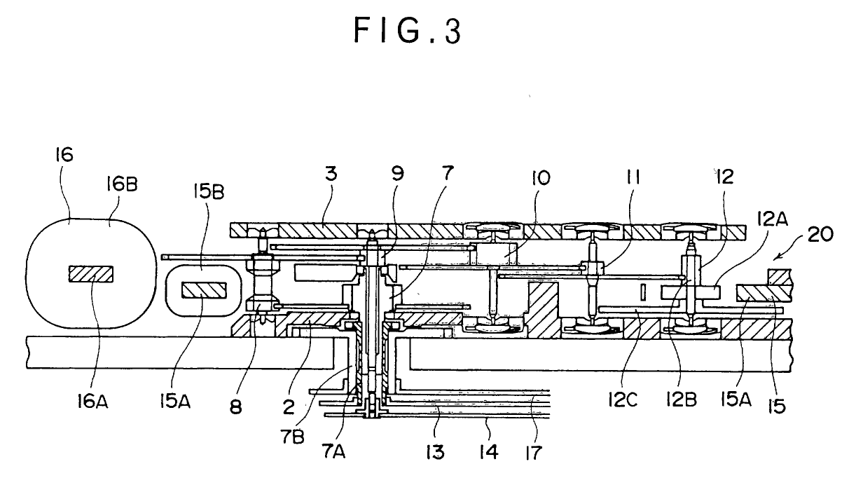

FIGS. 1 to 3 shows an electric-controlled mechanical timepiece according to first embodiment of the present invention. FIG. 1 is a cross section of a primary portion of the first embodiment, FIG. 2 is a cross section taken along II-II line in FIG. 1 and FIG. 3 is another cross section taken along III-III line in FIG. 1.

The electric-controlled mechanical timepiece is a device according to the present invention, where a mainspring 1A accommodated inside a barrel gear 1 is a driving mechanism to drive a power generator 20 by the mainspring 1A and regulates the drive speed of the power generator 20 at a constant level to rotate the indicators 13, 14 and 17 engaged to the power generator 20 at a constant speed.

In the drawing, the barrel gear 1 is provided with a barrel 1B, a barrel arbor 1C and a barrel case 1D as well as the mainspring 1A.

The barrel arbor is supported by a base plate 2 and a gear train holder 3 and is fixed by a square-hole screw 5 to be integrally rotated with a ratchet wheel 4.

The ratchet wheel is meshed with a recoil click 6 which allows clockwise rotation without allowing counterclockwise rotation. Incidentally, since the mechanism for rotating the ratchet wheel 4 clockwise to wind up the mainspring 1A is the same as a self-winding or a hand-winding mechanical timepiece, description thereof is omitted.

The rotary drive force of the mainspring 1A is transmitted to the power generator 20 through a speed-up gear train composed of gears 7 to 11.

Specifically, the revolution number is multiplied by seven from the barrel 1B to a second wheel 7, the revolution number is multiplied by six point four from the second wheel 7 to a third wheel 8, the revolution number is multiplied by nine point three seven five from the third wheel 8 to a sweep second wheel 9, the revolution number is multiplied by three from the sweep second wheel 9 to the fifth wheel 10, the revolution number is multiplied by ten from the fifth wheel 10 to a sixth wheel 11, and the revolution number is multiplied by ten from the sixth wheel 11 to a rotor 12. Accordingly, the rotary drive force of the barrel 1B is transmitted to the rotor 12 multiplied by one hundred twenty six thousands.

The gears 7 to 11 constitute a mechanical energy transferring device for transferring the mechanical energy of the mainspring 1A as a mechanical energy source to the power generator 20.

The second wheel 7 has a cannon-pinion 7A and a minute hand 13 fixed to the cannon-pinion 7A. A second hand 14 is fixed to the sweep second wheel 9. An hour hand 17 is fixed to an hour wheel 7B.

The rotary speed of the barrel 1B is regulated so that the second wheel 7 rotates once per hour and sweep second wheel 9 rotates once per minute, thereby setting the rotary speed of the rotor 12 at eight rotations per second. The rotary speed of the barrel 1B is one-seventh per hour. The hands 13, 14 and 17 constitute a time indicator for indicating time.

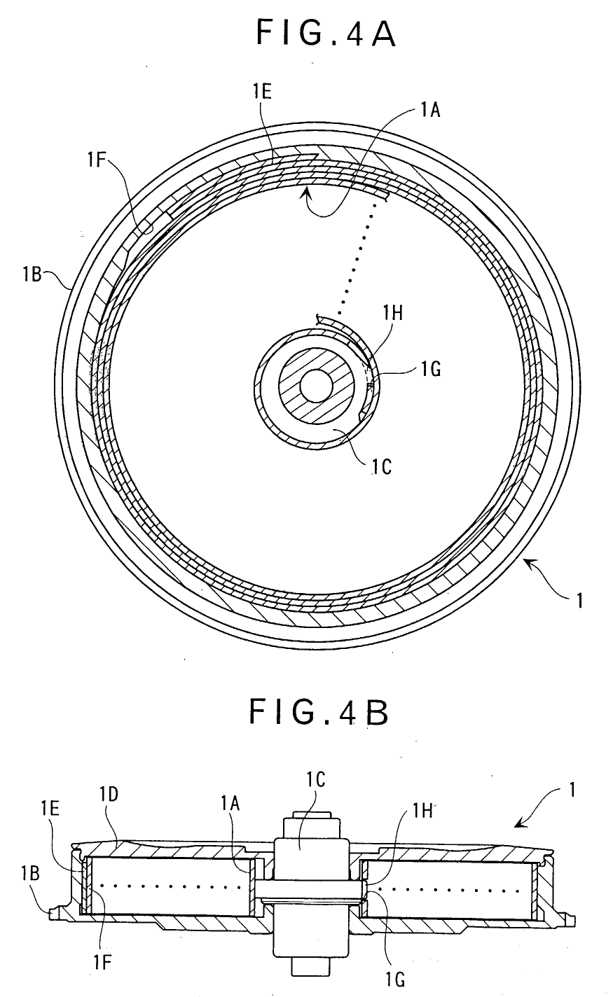

The mainspring 1A as a mechanical energy source has a band-shaped entire configuration and is wound in helical shape as shown in FIG. 4. FIG. 4(A) is a flat cross section horizontally cutting the barrel gear 1 and FIG. 4(B) is a vertical cross section vertically cutting the barrel gear 1.

An engage portion 1E thicker than the other portion is provided on an outer end of the mainspring 1A and is fixed to a recess 1F provided on an inner side of the barrel gear 1. By fixing the engage portion 1E to the recess 1F, the clockwise rotary drive force generated by the wound mainspring 1A is received by the barrel gear 1.

On the other hand, an engage hole 1G penetrating the front and back of the mainspring 1A is provided on an inner end of the mainspring 1A and is engaged to a projection 1H provided on a side of a barrel arbor 1C. The engagement of the engage hole 1G with the projection 1H enables the clockwise rotary drive force of the barrel arbor 1C to be received by the wound-back mainspring 1A.

Accordingly, the mainspring 1A is wound up by the clockwise rotary drive force applied to the ratchet wheel 4.

The mainspring 1A is formed by processing a material having superior toughness and durability composed of alloy including chromium, cobalt and nickel in a band-shape. Incidentally, main components and content ratio thereof (weight percent) forming the material of the mainspring 1A are as follows.

Co: 30 to 45%, Ni: 10 to 20%, Cr: 8-15%, W: 3 to 5%,

Mo: 3 to 12%, C: less than 0.03%, Ti: 0.1 to 2%, Mn: 0.1 to 2%

Si: 0.1 to 2%, Fe: the rest.

Films having different mechanical characters are coated on both sides of the mainspring 1A. Incidentally, tradename SPRON (manufactured by SEIKO CORPORATION) may be used as an alloy for forming the mainspring 1A.

The film is a thin film composed of carbon-amorphous rigid diamond-like carbon (referred to “DLC” hereinafter) harder than the material. The film is formed on the surface of the material by high-vacuum arc discharge vapor evaporation using solid carbon. The vapor evaporation by the high-vacuum arc discharge is a physical vapor evaporation capable of depositing vapor at a film-forming temperature around room temperature, e.g. twenty to sixty degrees Celsius.

The film has superior anti-corrosion properties without being dissolved into acid or alkali, and has smooth surface having friction coefficient of approximately 0.1. The film gives the surface of the mainspring 1A a superior anti-corrosion property and a great self-lubricity.

The film of DLC harder than the alloy-made material is provided to secure sufficiently great Young's modulus. Further, the film is made thinner than usual as long as sufficient toughness can be secured. Accordingly, the thickness of the spring 1A is smaller than an ordinary mainspring capable of generating the same torque.

Back to FIGS. 1 to 3, the power generator 20 has the rotor 12, a stator 15 and a coil block 16. The rotor 12 has a rotor magnet 12A, a rotor pinion 12B and an inertial disk 12C. The inertial disk 12C is for relaxing drive torque fluctuation from the barrel 1B to lessen frequency fluctuation of the rotor 12. The stator 15 has a forty-thousand-turned stator coil 15B wound around a stator body 15A.

The coil block 16 has a one-hundred-ten-thousand turned coil 16B wound around a magnetic core 16A. The stator body 15A and the magnetic core 16A are composed of a magnetic substance such as PC Permalloy. The stator coil 15B and the coil 16B are serially connected to add the mutual output voltages.

The rotary speed of the power generator 20 is regulated to a predetermined speed by a rotation control circuit 23 described below. Incidentally, though the rotary speed of the power generator 20 is set at a single value in a normal timepiece, the rotary speed is switchable to a plurality of values in a timepiece such as a chronograph.

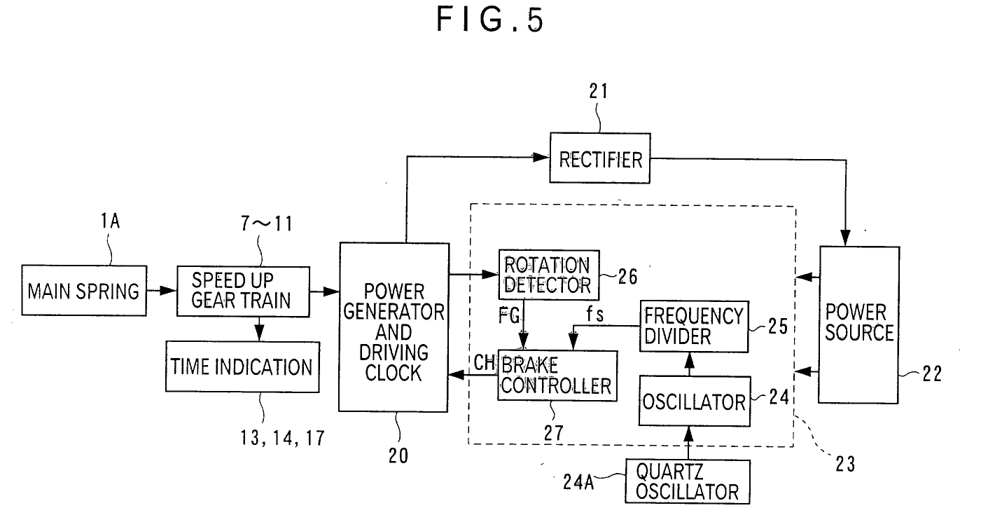

FIG. 5 shows a circuit arrangement including the rotation control circuit 23 in the first embodiment.

The power generator 20 is an alternating-current generator for generating an induced electromotive force by the rotary drive force of the mainspring 1A. The alternating output from the power generator 20 is voltage-raised and converted to a direct current by a rectifier 21 also for boosting, and is supplied to a power source 22 including a capacitor.

The rotation control circuit 23 has an oscillator for outputting a signal of predetermined frequency, a frequency divider 25 for dividing frequency of the signal outputted by the oscillator 24, a rotation detector 26 for detecting the rotation speed of the rotor 12 provided to the power generator 20, and a brake controller 27 for controlling brake force applied to the rotor 12.

The oscillator 24 is an oscillating circuit using a quartz oscillator 24A capable of stably oscillating at a predetermined frequency (32.768 kHz) scarcely being influenced by temperature change etc. The rotation of the rotor 12 is adjusted based on the oscillation of the oscillator 24.

The frequency divider 25 has a twelve-stage flip-flop for outputting a low frequency (8 Hz) signal fs divided from the predetermined frequency (32.768 kHz) signal outputted by the oscillator 24.

The rotation detector 26 outputs a rotation detection signal FG as a signal corresponding to a rotary speed to the rotor 12 of the power generator 20. The rotation detection signal FG is extracted by waveform-shaping of the output voltage of the power generator 20 through a band-pass filter in order to remove noise.

The brake controller 27 compares the signal fs as a rotary speed standard with a rotation detection signal FG and adjusts the electric current flowing in the stator coil 15B and the coil 16B of the power generator 20 in accordance with compared result, thus adjusting brake force of an electromagnetic brake applied to the rotor 12 of the power generator 20.

For instance, in order to minutely adjust the brake force of the electromagnetic brake applied to the rotor 12, an arrangement having a circuit serially connecting a switching element such as a transistor and a direct-current resistance can be used to conduct a high-speed on-off operation of the switching element to adjust on-time relative to off-time to minutely adjust the brake force of the electromagnetic brake.

When the frequency of the rotation detection signal FG relative to the signal fs is high by the brake controller 27, the on-time relative to the off-time is lengthened to strengthen the brake force of the electromagnetic brake. On the other hand, when the frequency of the rotation detection signal FG is low relative to the signal fs, the brake controller 27 shorten the on-time relative to the off-time to weaken brake force of the electromagnetic brake to indicate accurate time by the pointers 13, 14 and 17.

According to the above first embodiment, following advantages can be obtained.

Since the mainspring 1A is formed by components having different mechanical characteristics such as an alloy-made material and DLC film, the toughness can be secured by the material and sufficient Young's modulus can be secured by the rigid film, so that proportional limit of the mainspring 1A can be increased to increase energy amount accumulated in the mainspring 1A.

Since the DLC film having superior anti-corrosion properties and having smooth surface and low friction coefficient is used to cover the material, great anti-corrosive properties can be applied to the mainspring 1A and, since slide resistance thereof can be reduced, loss of friction can be reduced in extracting the rotary drive force from the mainspring 1A to obtain greater torque.

Accordingly, since the energy which can be accumulated in the mainspring 1A as a driving mechanism can be increased, the time for continuously driving the electronic control mechanical timepiece becomes longer than a general mainspring of the same size, thereby lengthening duration of the drive of the electronic control mechanical timepiece.

Further, since the DLC film harder than the alloy-made material is used to secure sufficient magnitude of Young's modulus by the film and the thickness of the material is reduced within a range capable of obtaining sufficient toughness to reduce thickness of the mainspring 1A, effective winding number of the mainspring 1A from being completely unwound to being wound to the limit can be increased, thereby also increasing the energy which can be accumulated in the mainspring 1A.

Since the mainspring 1A is a spring formed in a band-shape and in helical configuration, energy can be suitably accumulated mechanically, so that energy accumulation can be increased as compared to the other form of spring of the same size, thereby increasing energy density.

Further, since the film is formed by vapor evaporation by a high-vacuum arc discharge using a solid carbon, even when the film is formed on the surface of the material after thermal treatment of the material such as hardening and tempering, because the vapor evaporation by the high-vacuum arc discharge is a physical vapor depositing capable of depositing vapor at a film-forming temperature around the room temperature such as twenty to sixty degrees Celsius, the material is not thermally influenced, thereby preserving characteristics of the material after forming the film.

[Second Embodiment]

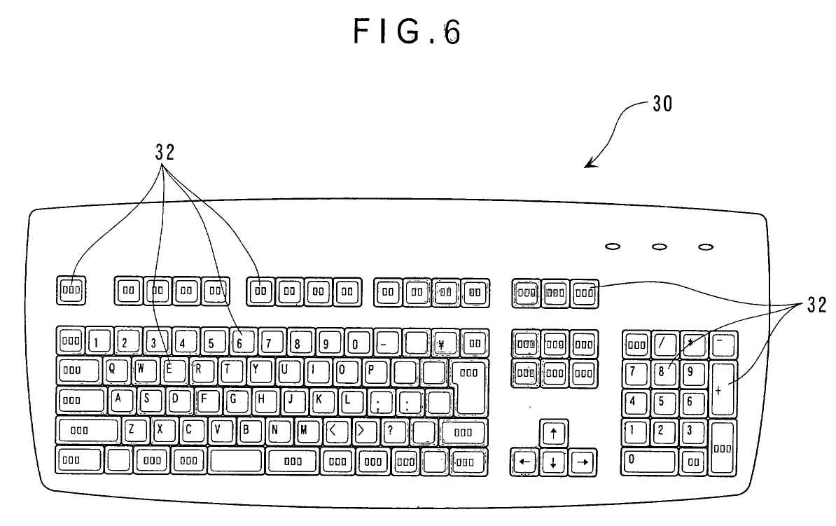

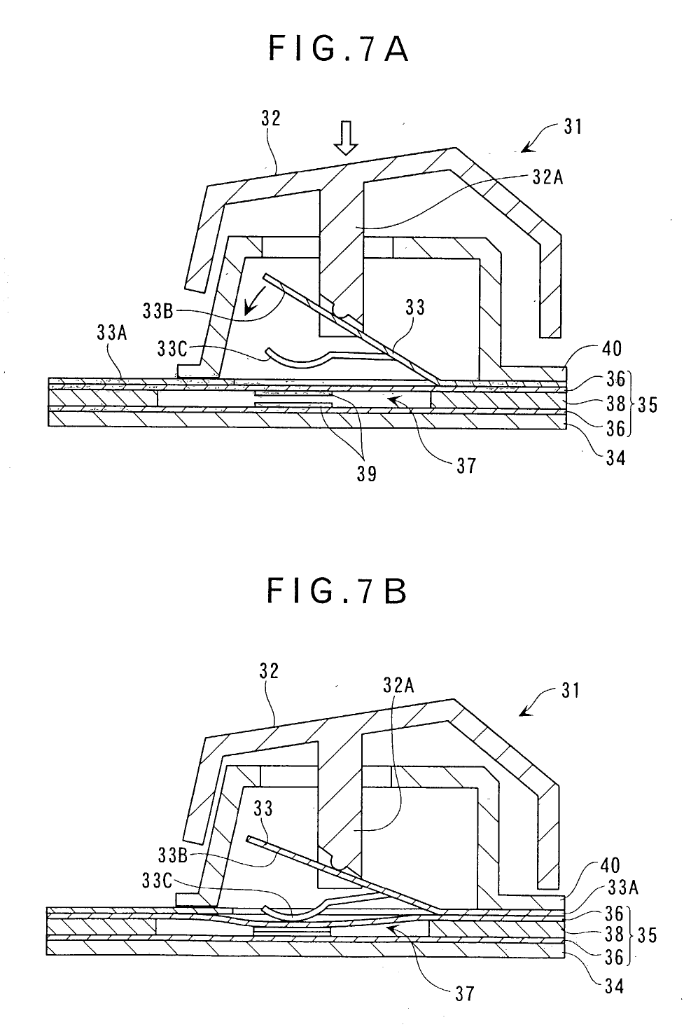

FIGS. 6 and 7 shows the second embodiment of the present invention. The second embodiment uses a mainspring 1A of the spring of the above-mentioned first embodiment as a plate spring 33 for biasing a push button 32 as a key 31 of a keyboard 30.

In FIG. 6, the keyboard 30 is a manual inputting device for a personal computer and includes a plurality of keys 31.

Respective keys 31 have, as shown in FIG. 7(A), a relatively rigid reinforcing plate 34 without being bent by a pressing force applied to the push button 32 in operation and a membrane contact point portion 35 disposed on the reinforcing plate 34.

The membrane contact point portion 35 has a pair of electrode sheets 36 having flexibility and electrode pattern formed on the inner surface thereof, and a spacer plate 38 provided between the electrode sheets 36 and having holes 37 corresponding to the position of the push buttons 32. A pair of contact points 39 opposing inside the holes 37 of the spacer plate 38 are provided on the respective sheets 36.

A plate spring sheet 33A integrally formed with the plate spring 33 is provided on an upper side of the membrane contact point portion 35. The plate spring sheet 33A has a relatively rigid flat-plate material. The composition of the material of the plate spring sheet 33A may be a synthetic resin having relatively great elasticity such as polypropylene, polyamide, polyacetal and polytetrafluoroethylene, or metal.

A surface of the plate spring sheet 33A on the side of the membrane contact point portion 35 has the DLC film formed by vapor evaporation of high-vacuum arc discharge. Even when the material is formed of a composition unable to secure sufficient bonding strength of the film to the material, since the film is formed on the surface 33B applied with the compressive force, the film is not peeled off from the material when the plate spring 33 is deformed.

The plate spring 33 is formed by cutting and raising a part of the plate spring sheet 33A in a direction opposite to the membrane contact portions 35. The material of the plate spring 33 is coated with the DLC film on the surface 33B onto which the compressive force is applied during elastic deformation.

A pressing portion 33C is formed by cutting and raising a part of the plate spring 33 to the side of the membrane contact point portion 35. The plate springs 33 and the pressing portion 33C are accommodated in the box-shaped housing 40 formed on the upper side of the plate spring sheet 33A.

The push button 32 is a box-shaped member slightly greater than the housing 40 covering the housing 40 and provided to the keyboard 30 in a vertically movable manner. A projection 32A extending toward the plate spring 33 is provided inside the push button 32.

Accordingly, when the push button 32 is pressed against the biasing force of the plate spring 33, the projection 32A presses the pressing portion 33C toward the membrane contact point portion 35 side through the plate spring 33 as shown in FIG. 7(B) to bring the pair of contact points 39 inside the membrane contact point portion 35 into mutual contact.

According to the second embodiment, following advantage can be obtained.

Since the DLC film is formed on the surface 33B on the side of the membrane contact point portion 35 of the plate spring sheet 33A by high-vacuum arc discharge vapor evaporation so that only the compressive force is applied to the film by deforming the plate spring 33 and tension is not applied, even when the material is formed of a composition unable to secure sufficient bonding strength of the film to the component, the film does not peel off from the material, thus improving durability of the plate spring 33.

[Third Embodiment]

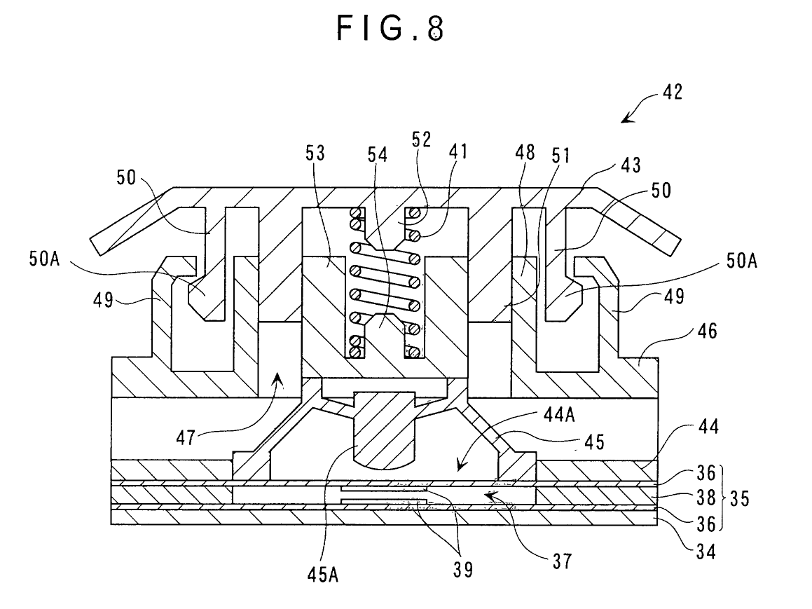

FIG. 8 shows a third embodiment of the present invention. The third embodiment uses the plate spring 33 of the second embodiment as a coil spring 41.

In FIG. 8, a key 42 brings the contact points 39 inside the membrane contact point portion 35 provided on the reinforcing plate 34 into mutual contact by the pressing force applied to the push button 43.

The upper portion of the membrane contact point portion 35 is covered with a flat cover 44. A hole 44A is formed on the cover 44 corresponding to the position of the contact points 39 provided on the membrane contact point portion 35. A rubber spring 45 having a material of synthetic resin elastomer is fitted to the hole 44A.

The rubber spring 45 has the DLC film formed on the entire surface of the synthetic resin elastomer material. The film is formed by vapor evaporation by the high-vacuum arc discharge. The film gives the rubber spring 45 a superior anti-corrosion properties preventing dissolution to acid, alkali and organic solvent. Further, even when the synthetic resin elastomer as the material thereof is soft and sufficient elasticity cannot be obtained solely by the material, the rubber spring 45 has sufficient elasticity by the DLC film. A cylindrical projection 45A is formed on the rubber spring 45 for pressing the membrane contact point portion 35.

The reinforcing plate 34, the membrane contact point portion 35, the cover 44 and the rubber spring 45 are provided in a housing 46 forming a chassis of the keyboard 30.

A hole 47 formed to a position corresponding to the contact point 39 provided on the membrane contact point portion 35, a cylindrical guide 48 extending upward surrounding the hole 47, and a retaining portion 49 having L-shaped cross section disposed outside the guide 48 are provided to the housing 46.

An engaging projection 50 having a claw 50A engaged to the retaining portion 49 of the housing 46, a cylindrical slide guide 51 having outer circumference in contact with the guide 48 for guiding the vertical movement of the push button 43, and a projection 52 for engaging the coil spring 41 for preventing horizontal movement thereof are provided on the backside of the push button 43.

A bottomed-cylindrical slide member 53 is slidably provided inside the cylindrical slide guide 51.

The slide member 53 has a projection 54 on the bottom thereof for engaging the coil spring 41 to prevent horizontal movement. The coil spring 41 is interposed between the slide member 53 and the push button 43, and the rubber spring 45 is interposed between the slide member 53 and the membrane contact point portion 35.

Accordingly, when the push button 43 is pressed against the biasing force of the coil spring 41 and the rubber spring 45, the projection 45A of the rubber spring 45 presses the membrane contact point portion 35 to bring the pair of contact points 39 inside the membrane contact point portion 35 into contact with each other.

The coil spring 41 has the DLC film formed on the entire surface of a linearly shaped steel-made material. The film is formed by vapor evaporation by high-vacuum arc discharge. The coil spring 41 has superior anti-corrosive properties without being dissolved into acid or alkali on account of the film and has decreased friction coefficient on the surface thereof.

According to the third embodiment, following advantages can be obtained.

Since the rubber spring 45 having the DLC film formed on the entire surface of a synthetic resin elastomer material is used, the rubber spring 45 can have superior anti-corrosive properties without being dissolved into acid, alkali and organic solvent. Further, when the synthetic resin elastomer is too soft to have sufficient elasticity solely by the material, sufficient elasticity can be given to the rubber spring 45 by the DLC film. Accordingly, high-performance rubber spring 45 can be efficiently manufactured by forming the synthetic resin elastomer by injection molding etc.

Further, since the coil spring 41 has the DLC film formed on the entire surface of the linearly shaped steel-made material, superior anti-corrosive properties can be given to the steel-made material, thereby improving durability of the keyboard 30. Further, since the friction coefficient on the surface of the coil spring 41 can be reduced, smooth operation is possible, thereby improving operability thereof.

[Fourth Embodiment]

Fourth embodiment of the present invention has a film formed of diffusion layer where a diffusion substance is diffused from the surface of the material by a vacuum diffusion method instead of the thin film formed by the physical vapor deposition in the first embodiment. The arrangement of the fourth embodiment is the same as the above-described first embodiment except for the film formed on the mainspring 1A, and the film composed of diffusion layer will be described below and the description for the other component will be omitted.

The film is a diffusion layer where nitrogen strongly bonded with chromium contained in the alloy as the material of the mainspring 1A is used as the diffusion substance, which is formed by vacuum gas nitriding treatment for diffusing the nitrogen into the inside of a material inside a high-vacuum furnace.

The vacuum gas nitriding treatment may be, for instance, “Kanuc treatment” and “new Kanuc treatment” of Kanuc CORPORATION.

The outline of “Kanuc treatment” is: Supplying a nitriding accelerating gas mainly containing NH₃ having nitrogen atom into the vacuum furnace with high-vacuum and the material being disposed therein; Heating the material (heating temperature: 480 to 550° C., heating time: three to five hours); and diffusing the nitrogen inside the material to form the diffusion layer of the nitrogen.

The “new Kanuc treatment” is for further strengthening the diffusion layer formed in the “Kanuc treatment”, where heat energy is applied again on the diffusion layer of the material treated with “Kanuc treatment” to form first diffusion layer having higher density of nitrogen atom than the diffusion layer by the “Kanuc treatment” on the surface thereof and the second diffusion layer having lower density of the nitrogen atom than the first diffusion layer on the backside of the first diffusion layer, thereby forming double structured diffusion layer.

According to the fourth embodiment, the same functions and advantages as the first embodiment can be obtained. Further, since rigid diffusion layer is formed by diffusing nitrogen inside the material, fragile layer is not formed on the border between the diffusion layer and the material, so that damage or peeling of the diffusion layer can be prevented after repeating elastic deformation, thereby obtaining a mainspring 1A having superior durability.

Next, an effect of the present invention will be described below with reference to specific experiments.

[Experiment]

The present experiment is for exemplifying that the mainspring 1A provided to the barrel gear as the driving mechanism in the above-described first and fourth embodiment can accumulate more energy than a conventional mainspring.

In the experiments, the experiment 1 used a mainspring 1A having DLC thin layer formed on the surface of SPRON-made material and the experiment 2 used a mainspring 1A having nitrogen diffusion layer formed by “Kanuc treatment” on the surface of SPRON-made material.

In the experiment 1, the thickness of the mainspring 1A was reduced as long as a predetermined torque could be obtained, where the mainspring 1A was accommodated in a barrel gear 1 having inner diameter of 11.1 mm, a diameter of barrel arbor of 2.8 mm, and thickness of the peripheral sidewall of the barrel of 1.45 mm. The number capable of winding the mainspring from unwound condition to completely wound-up condition was measured.

In the experiment 2, the “Kanuc treatment” was used in order to form the diffusion layer on the material, and production of the mainspring 1A having the same performance as the experiment 1 was tried and, as a result, the mainspring 1A having the same performance as the experiment 1 could be obtained.

Dimensions of respective portions of the mainspring 1A, Young's modulus, maximum torque T and winding number N according to the experiments 1 and 2 are shown in Table 1.

TABLE 1

| | Thickness of | Width of | Length of | Young's | Maximum | |
|---|---|---|---|---|---|---|
| | mainspring | mainspring | mainspring | modulus | torque T | Winding |
| | (mm) | (mm) | (mm) | (Pa) | (N/m) | number N |
| Experiment 1 | 0.12 | 1.4 | 408 | 3.0 × 10¹⁰ | 1.3 × 10⁻² | 8.4 |
| Experiment 2 | 0.12 | 1.4 | 408 | 3.0 × 10¹⁰ | 1.3 × 10⁻² | 8.4 |
| Comparison | 0.13 | 1.4 | 370 | 2.3 × 10¹⁰ | 1.3 × 10⁻² | 7.6 |

[Comparison]

The comparison is an example of conventional mainspring for comparing with the mainspring 1A of the experiments.

In the comparison, simple SPRON-made mainspring capable of obtaining maximum torque as the mainspring 1A was used. The mainspring was accommodated in the same barrel gear 1 and the number capable of winding the mainspring from unwound condition to completely wound-up condition was measured.

The dimensions of respective portions of the mainspring, Young's modulus, maximum torque T and winding number N are shown in Table 1.

[Comparing Experiments and Comparison]

When the experiments 1 and 2 and the comparison were compared, the experiments 1 and 2 allowed more winding number of the mainsprings, thus extending duration for driving the electronic control mechanical timepiece, so that energy amount could be increased by 11% in the experiments as compared to the comparison.

When the mainspring of the experiments 1 and 2 is applied to a simple mechanical timepiece, the energy accumulation capable of being accumulated in the mechanical timepiece can be increased by 11%, thus extending duration for driving the mechanical timepiece.

Incidentally, the present invention is not limited to the respective embodiments and experiments, but includes improvements and modifications as long as an object of the present invention can be achieved.

For instance, the mainspring is not limited to those having rigid film on both sides thereof, but a mainspring having the rigid film solely on single center (inner) side of helically wound spring and having no rigid film on the other peripheral (outer) side may be used.

Accordingly, though a compression stress is constantly applied to the rigid film, tensile stress is not applied thereto, so that the rigid film is not damaged even when a great stress is applied in winding the mainspring since the rigid film is highly durable against the compression stress. Further, since the rigid film is formed on one side of the mainspring, the thickness of the rigid film can be restrained to the minimum to reduce the thickness of the entire mainspring and winding number can be increased thereby, so that duration of driving the mainspring can be lengthened.

Further, when the rigid film is formed on both sides of the mainspring, one of the rigid films formed on one side may have greater thickness than the other rigid film provided to the other side. For instance, the rigid film formed on the surface where the compression force is applied may be made thick and the rigid film formed on the surface where the tensile stress is applied may be made thin. Alternatively, the type of the rigid film formed on both sides may differ. In other words, a rigid film having characteristic different from the rigid film formed on one side may be formed on the other side.

The material of the spring component is not restricted to the alloy described in the embodiments, steel and synthetic resin, but may be other alloys such as stainless steel, metal and non-metal. According to the present invention, even when the material of the spring component has not so superior characteristics, the performance of the spring can be improved by coating the film.

The thin film to be the film is not restricted to the DLC thin film, but may be thin film of polycrystal or single crystal diamond, ceramic thin film such as silicon nitride, silicon carbide, aluminum oxide, titanium carbide, titanium nitride, and cubic boron nitride, or metal thin film such as nickel-phosphorus plating.

The film forming method of the thin film is not limited to the vapor evaporation by the high-vacuum arc discharge, but may be physical film-forming method such as other vapor evaporation, sputtering and ion plating method, and chemical film-forming method such as heat CVD, plasma CVD and optical CVD. However, a method having film-forming temperature around room temperature may preferably be used.

The diffusion layer as the film is not limited to the diffusion layer of nitrogen, but may be a diffusion layer composed of other element such as carbon, beryllium, molybdenum, tungsten, vanadium, titanium and tantalum diffused into the material when the material is steel.

The diffusion layer as the film may be formed not only by gas diffusion treatment such as “Kanuc treatment” and “new Kanuc treatment” but by solid diffusion method where a solid diffusion agent and the material is put into a diffusion furnace and sealed therein or by liquid diffusion method where the material is soaked in liquid containing diffusion substance and is heated therein. However, since the material is not deformed by the “Kanuc treatment” and “new Kanuc treatment” as in the fourth embodiment even after the diffusion treatment, a spring suitable for a timepiece as a precision device can be manufactured.

The film formed on the material is not restricted to a single layer but may be a plurality of different type layers. Accordingly, if bonding strength to the material, anti-corrosion properties of spring and slide properties cannot be improved only by a single film, by providing a plurality type of films having different characteristics, the bonding strength can be improved by one film, and the anti-corrosion properties and slide properties can be improved by the remaining film, thus achieving high-performance spring.

For instance, a first composition having great rigidity and small bonding strength to the material and a second composition which strongly adheres both to a first film and the material may be prepared, and a second film composed of the second composition may be directly formed on the material and a first film composed of the first composition may be formed on the second film, thereby improving bonding strength of the film.

Alternatively, a first composition having great rigidity and inferior anti-corrosion properties and self-lubricity and a second composition superior both in the anti-corrosion properties and self-lubricity may be prepared, and a first film composed of the first composition may be formed directly on the material and the second film composed of the second composition may be formed on the first film, thereby improving both of the anti-corrosion property and self-lubricity of the spring.

Further, the timepiece is not restricted only to the electronic control mechanical timepiece for controlling the rotary speed of the power generator but may be a normal mechanical timepiece for controlling rotary speed by a balance and an escape wheel. Further, the barrel may not only be single but more than one barrels may be provided.

Industrial Availability

The present invention relates to a spring used as a machine element, a driving mechanism, a device and a timepiece using the spring, which can, for instance, be suitably used for a helical spring for driving intake valve and exhaust valve of a gasoline engine, shock absorber around wheels of a vehicle, power source of toys, timepiece, music box etc.

1. A spring manufactured by processing an elastic material, at least a part of the surface of the material formed with a film having composition and mechanical characteristics different from the material.

2. The spring according to claim 1, wherein the film is harder than the material.

3. The spring according to claim 1 or 2, wherein a plurality of layers of the film are provided.

4. The spring according to any one of claims 1 to 3, wherein the material is processed in a band-shape and wound in helical shape so that the spring becomes a mainspring.

5. The spring according to any one of claims 1 to 4, wherein the film is formed on a surface to which a compressive force is applied when the material is elastically deformed.

6. The spring according to any one of claims 1 to 5, wherein the film is a thin film of a substance harder than the material coated on the surface of the material.

7. The spring according to claim 6, wherein the material is formed of a non-metal.

8. The spring according to claim 6 or 7, wherein the thin film is formed on the material by a physical vapor evaporation of which film-forming temperature is around, a room temperature.

9. The spring according to any one of claims 1 to 5, wherein the film is a diffusion layer formed harder than the material by diffusing a diffusion substance strongly bonded with a composition constituting the material from the surface of the material to the inside.

10. The spring according to claim 9, wherein the material is formed of a metal capable of thermomigration treatment.

11. The spring according to claim 9 or 10, wherein the diffusion layer is formed on the material by a diffusion treatment which supplies a gas including a molecule containing element of the diffusion substance into a high-vacuum furnace and the diffusion substance is diffused from the surface of the material to the inside.

12. A driving mechanism using a spring according to any one of claims 1 to 11 as a power source.

13. A device using a spring according to any one of claims 1 to 11.

14. An electronic control timepiece, comprising:
a mechanical energy accumulator for accumulating a mechanical energy;
a power generator driven by the mechanical energy accumulator;
a gear train for mutually connecting the mechanical energy accumulator and the power generator;
an indicator connected to the gear train; and
a rotation controller for controlling rotary speed of the power generator,
wherein the spring according to any one of claims 1 to 11 is used as the mechanical energy accumulator.

15. A timepiece comprising a mechanical energy accumulator and being driven by the mechanical energy accumulator, wherein the spring according to any one of claims 1 to 11 is used as the mechanical energy accumulator.
